(19) United States
(12) Patent Application Publication
(10) Pub. No.: US 2010/0177495 A1
(43) Pub. Date: Jul. 15, 2010

(54) ILLUMINATION SYSTEM, COLLIMATOR AND SPOTLIGHT

(75) Inventors: Denis Joseph Carel Van Oers, Eindhoven (NL); Lars Rene Christian Waumans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/602,229

(22) PCT Filed: May 30, 2008
(86) PCT No.: PCT/IB2008/052111

§ 371 Date: Nov. 30, 2009

(30) Foreign Application Priority Data
Jun. 5, 2007 (EP) 07109593.9

(51) Int. Cl. F21V 9/16

(52) U.S. Cl. 362/84

(57) ABSTRACT

The invention relates to an illumination system (10, 12), a collimator (30, 32) for use in the illumination system and a spotlight. The illumination system comprises a light emitting diode (20), a collimator and a luminescent layer (40). The light emitting diode emits light via the luminescent layer and the collimator in a direction away from the illumination system. The collimator comprises a light input window (34) for receiving light from the light 5 emitting diode. The collimator further comprises a light exit window (36) for emitting a collimated beam of light. The light substantially progresses through the collimator via total internal reflection. The luminescent layer comprises luminescent material which converts at least part of the light emitted by the light emitting diode into light of a predefined color. The luminescent layer is applied to the light input window of the collimator.10 The effect of the measures according to the invention is that the application of the luminescent layer on the light input window of the collimator results in improved color uniformity and enables a remote phosphor arrangement while maintaining a collimated beam.

### FIELD OF THE INVENTION

The invention relates to an illumination system comprising a light emitting diode, a collimator and a luminescent layer.

The invention also relates to a collimator for use in the illumination system, and to a spotlight comprising the illumination system.

### BACKGROUND OF THE INVENTION

Such illumination systems are known per se. They are used, inter alia, in spotlights. A spotlight is a lamp that produces a collimated beam of light to illuminate a restricted area. The spotlight may be used for general lighting purposes, for example, for office lighting, or for shop lighting, or for in-home general lighting purposes, or for theater lighting for illuminating part of the stage.

Light emitting diodes are increasingly being used in illumination systems for general lighting purposes. The reason is that the efficiency and life-time of the light emitting diodes is relatively high, while the cost of the light emitting diodes is relatively low. Furthermore, the use of light emitting diodes enables a miniaturization of the illumination system. Generally, light emitting diodes produce light having a relatively narrow spectrum. However, in general, lighting applications emitting white light having a relatively broad spectrum are preferred, for example, such that the light produced by the illumination system has a relatively high color rendering index. To convert the substantially narrow spectrum emitted by the light emitting diode into a substantially broad spectrum, luminescent materials are generally applied which absorb light emitted by the light emitting diode and convert the absorbed light into light of a different color. The luminescent material is generally directly applied to the die of the light emitting diode. Such light emitting diodes comprising luminescent material are also known as phosphor-enhanced light emitting diodes.

A drawback when using the phosphor-enhanced light emitting diode in the known illumination system is that the color-uniformity of the light emitted by the known illumination system is not optimal.

### SUMMARY OF THE INVENTION

It is an object of the invention to improve the color-uniformity of the emitted light.

According to a first aspect of the invention the object is achieved with an illumination system according claim 1. According to a second aspect of the invention, the object is achieved with a collimator as claimed in claim 8. According to a third aspect of the invention, the object is achieved with a spotlight as claimed in claim 9. The illumination system according to the invention comprises a light source, a collimator and a luminescent layer,

the light source emitting light via the luminescent layer and the collimator in a direction away from the illumination system,

the collimator being arranged for collimating the light emitted by the light source to generate a beam of light, the collimator having a light input window for receiving light from the light source and having a light output window for emitting the beam of light, the light progressing through the collimator substantially via total internal reflection,

the luminescent layer comprising a luminescent material being arranged for converting at least part of the light emitted by the light source into light of a predefined color, the luminescent layer being applied to the light input window of the collimator.

The effect of the illumination system according to the invention is that the application of the luminescent layer to the light entrance window of the collimator enables the application of a more even layer of luminescent material, which results in a more color uniform emission of light from the illumination system. In the known phosphor-enhanced light emitting diodes, the luminescent layer is applied directly on the die. Generally, the luminescent material is liquidized, for example, via heating or by using a solvent. Subsequently a droplet of luminescent material is applied to the die of the light emitting diode. After hardening of the droplet of luminescent material the layer is formed over the die of the light emitting diode. Due to surface tension in the liquidized luminescent material before solidification, the distribution of the luminescent material inside, for example, the solvent is not even, resulting in a non-uniform distribution of the luminescent material in the luminescent layer of the known illumination system, causing the non-optimal color-uniformity of the light emitted by the known illumination system. In the illumination system according to the invention, the layer of luminescent material is applied to the light input surface of the collimator. Generally, the light input window is much larger than the die of the light emitting diode, thus simplifying the application of the luminescent layer such that a more even distribution of the luminescent material inside the luminescent layer is obtained. The luminescent layer may be applied to the entrance window of the collimator, using any of the known methods, for example, painted or coated, for example, spray-coated on the entrance window. Due to the improved distribution of the luminescent material inside the luminescent layer, the color-uniformity of the light emitted by the illumination system according to the invention is improved. Furthermore, light emitted by the light emitting diode and transmitted by the luminescent layer is generally diffusely scattered by the luminescent layer which results in a mixing of the light of the predefined color with the light emitted by the light emitting diode and transmitted by the luminescent layer. This further improves the color-uniformity of the light emitted by the illumination system according to the invention.

A further benefit when applying the luminescent layer on the light input window of the collimator is that the luminescent layer can be applied remote from the die of the light emitting diode while maintaining a collimated beam. In U.S. Pat. No. 7,049,740 a light emitting diode is shown which comprises a lens. A surface of the lens facing the die of the light emitting diode comprises a fluorescent material. Such a lens may be used to collimate the light emitted by the die via refraction. However, the application of the fluorescent material on the surface of the lens facing the die results in substantial loss of collimation characteristics of the lens. The light emitted by the light emitting diode which is converted by and/or scattered on the layer of fluorescent material will hardly be collimated. In the illumination system according to the invention, the light through the collimator substantially progresses through the collimator via total internal reflection. Also the light converted by the luminescent layer or scattered from the luminescent layer progresses through the collimator substantially via total internal reflection and is subsequently collimated by the collimator. As a result, the light emitted from the illumination system according to the invention is emitted in a collimated beam even though the luminescent layer is applied remote from the die of the light emitting diode.

This remote arrangement of the luminescent layer is also referred to as a remote phosphor configuration. A benefit when using the remote phosphor configuration is that the conversion efficiency and the life-time of the luminescent material are improved and that the range of luminescent materials to choose from is improved.

In this context, light of a predefined color typically comprises light having a predefined spectrum. The light of a predefined color includes, for example, light of a primary color having a specific spectral bandwidth around a predefined wavelength. Light of the primary color is, for example, red light, green light, blue light, cyan light, yellow light, etc.

In an embodiment of the illumination system, the collimator is exchangeably connected to the illumination system. A benefit of this embodiment is that the exchangeability of the collimator enables a relatively easy change of, for example, a shape of the beam emitted by the illumination system, and/or, for example, a color of the light emitted by the illumination system. The shape of the beam emitted by the illumination system according to the invention is determined by the collimator. Having an exchangeable collimator enables, for example, a user to exchange the collimator which generates a different shape of the beam of light emitted by the illumination system. Alternatively, the collimator may be exchanged with a collimator having a different luminous layer, which results in an illumination system in which the color of the light emitted by the illumination system is changed. As a result, a simple replacement of the collimator by a different collimator results in a different emission characteristic of the illumination system according to the invention. U.S. Pat. No. 7,108,386 discloses a high brightness LED phosphor coupling device. The device comprises an encapsulated semiconductor light source. In this device, the phosphor region is coupled to a non-imaging collimator secondary optic. However, the coupling of the phosphor in U.S. Pat. No. 7,108,386 is an optical coupling rather than a mechanical application of the luminescent layer to the light input window of the collimator as is done in the illumination system according to the invention. The phosphor region is integrated in the encapsulation of the semiconductor light source and thus is separate from the collimator. Due to this integration of the phosphor material in the encapsulation of the semiconductor light source, the color and/or beam shape of the light emitted by this known device cannot easily be changed. In the illumination system according to the invention, the luminescent layer is applied to the light input window of an exchangeable collimator. Exchanging the collimator in the illumination system according to the invention results in a relatively easy change of the color and/or beam shape of the light emitted by the illumination system.

An even further benefit of the illumination system according to the invention is that the number of components which make up the illumination system according to the invention is relatively low. The illumination system only comprises a light emitting diode and a collimator comprising a luminescent layer applied to the light input window. As a result, the illumination system according to the invention can be produced at relatively low cost.

In an embodiment of the illumination system, the collimator comprises an edge-wall connecting the light input window with the light output window, wherein at least part of the edge-wall has a substantially parabolic shape when viewed in a cross-sectional view being generated by intersecting the illumination system with an imaginary intersecting surface along a longitudinal axis of the collimator, the longitudinal axis extending in a direction of the beam of light. Especially when the light emitted into the collimator has a substantially Lambertian distribution, a parabolically shaped edge-wall enables a progression of the light through the collimator substantially via total internal reflection.

In an embodiment of the illumination system, the luminescent layer comprises a mixture of luminescent materials. For example, using a light emitting diode emitting ultraviolet light, the mixture of luminescent material may be chosen such that the ultraviolet light is converted by the luminescent layer into substantially white light emitted by the illumination system.

In an embodiment of the illumination system, the luminescent layer comprises a plurality of layers of luminescent materials. The application of the plurality of layers of luminescent materials enables a relatively easy change of color of the light emitted by the illumination system according to the invention. For example, when manufacturing the collimator the number of the applied layers of luminescent material determines a conversion of the light emitted by the light emitting diode into light of the predefined color, which determines a color of the light emitted by the illumination system.

In an embodiment of the illumination system, the luminescent materials in the individual layers of the plurality of layers are different. Selecting a specific combination of layers which comprises different luminescent materials enables a specific selection of the color of the light emitted by the illumination system.

In an embodiment of the illumination system, a central wavelength of the light emitted by light emitting diode is within a range between 400 nanometers and 490 nanometers. Light having a central wavelength in a range between 400 and 490 nanometers is also known as blue light. A benefit of using blue light as the light of the first predefined color is that this light is visible to humans and thus can directly be mixed into the output of the color-tunable illumination system without conversion. Any conversion using luminescent materials to convert light from one color to another introduces some loss of energy due to a Stokes-shift involved in the conversion. By using blue light as the light of the first predetermined color, some of the light emitted by the color-tunable illumination system does not need to be converted, which increases the efficiency of the system.

### BRIEF DESCRIPTION OF THE DRAWINGS

These and other aspects of the invention are apparent from and will be elucidated with reference to the embodiments described hereinafter.

In the drawings:

FIG. 1 shows a schematic cross-sectional view of an illumination system according to the invention,

FIG. 2 shows a schematic cross-sectional view of a further embodiment of the illumination system according to the invention, and

FIG. 3 shows a spotlight according to the invention.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF EMBODIMENTS

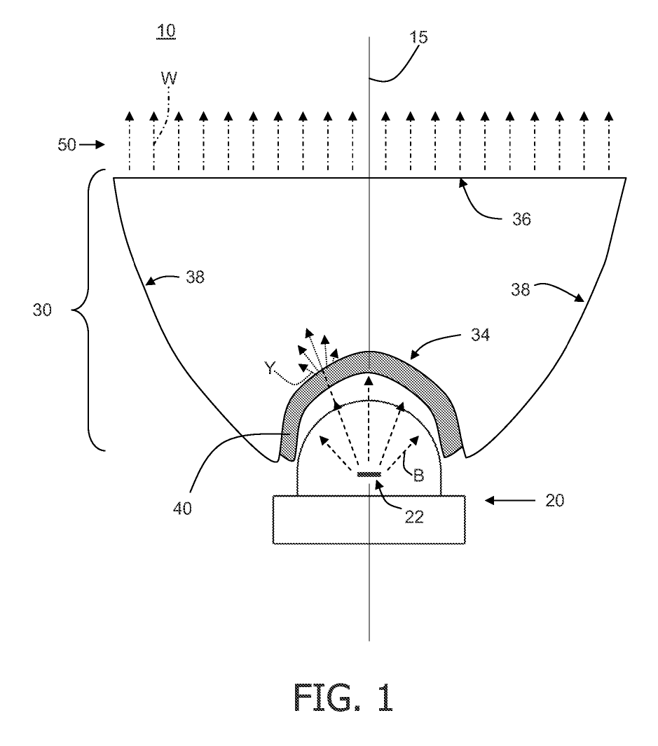

FIG. 1 shows a schematic cross-sectional view of an illumination system 10 according to the invention. The cross-sectional view shown in FIG. 1 is generated by intersecting the illumination system 10 with an imaginary plane (not shown) arranged parallel to the longitudinal axis 15. The illumination system 10 according to the invention comprises a light emitting diode 20, a collimator 30 and a luminescent layer 40. The light emitting diode 20 comprises a die 22 which emits light B via the luminescent layer 40 and the collimator 30 in a direction away from the illumination system 10. The luminescent layer 40 comprises a luminescent material which converts at least a part of the light emitted by the light emitting diode 20 into light of a predefined color Y. The collimator 30 is arranged for collimating the light B emitted by the light emitting diode 20 as well as the light Y to generate a beam of light 50 which is subsequently emitted from the illumination system 10. The collimator comprises a light input window 34 for receiving the light from the light emitting diode 20. The collimator 30 further comprises a light exit window 36 for emitting the beam of light 50. The light progresses through the collimator 30 substantially via total internal reflection.

In the embodiment shown in FIG. 1 the light B emitted by the die 22 of the light emitting diode 20 is, for example, light of the primary color blue B, indicated in FIG. 1 with dashed arrows. When the light of the primary color blue B impinges on the luminescent layer 40, part of the impinging light of the primary color B may, for example, be converted into light of a predefined color Y. In the current embodiment, the light of the predefined color Y is light of the primary color yellow Y, indicated in FIG. 1 with dotted arrows. A further part of the light of the primary color blue B emitted by the light emitting diode 20 is transmitted by the luminescent layer 40 and mixes with the light of the predefined color Y to generate a color of the beam of light 50 emitted by the illumination system 10. The amount of light of the primary color blue B emitted by the light emitting diode 20 and contributing to the color of the beam of light 50 emitted by the illumination system 10 is determined, for example, by a thickness of the luminescent layer 40 or, for example, by a concentration of luminescent material in the luminescent layer 40. Choosing a specific ratio between the light of the primary color blue B and light of the primary color yellow Y, substantially white light W can be generated as the color of the beam of light 50 emitted by the illumination system 10 according to the invention. This is indicated in FIG. 1 with dash-dot arrows. Because the light progresses through the collimator substantially via total internal reflection, also the light converted by the luminescent layer 40 will be collimated by the collimator 30 and contribute to the emitted beam of light 50.

Generally, the part of the light of the primary color blue B emitted by the light emitting diode 20 and transmitted by the luminescent layer 40 is partially diffused by the luminescent layer 40. The diffusing of the light of the primary color blue B improves the mixing of the light of the primary color blue B with the light of the primary color yellow Y emitted by the luminescent layer 40 inside the collimator 30, which improves the color-uniformity of the beam of light 50. Furthermore, due to the progression of the light through the collimator 30 via total internal reflection, the application of the luminescent layer 40 at the light input window 34 of the collimator 30 enables a remote phosphor arrangement while maintaining a collimated beam 50.

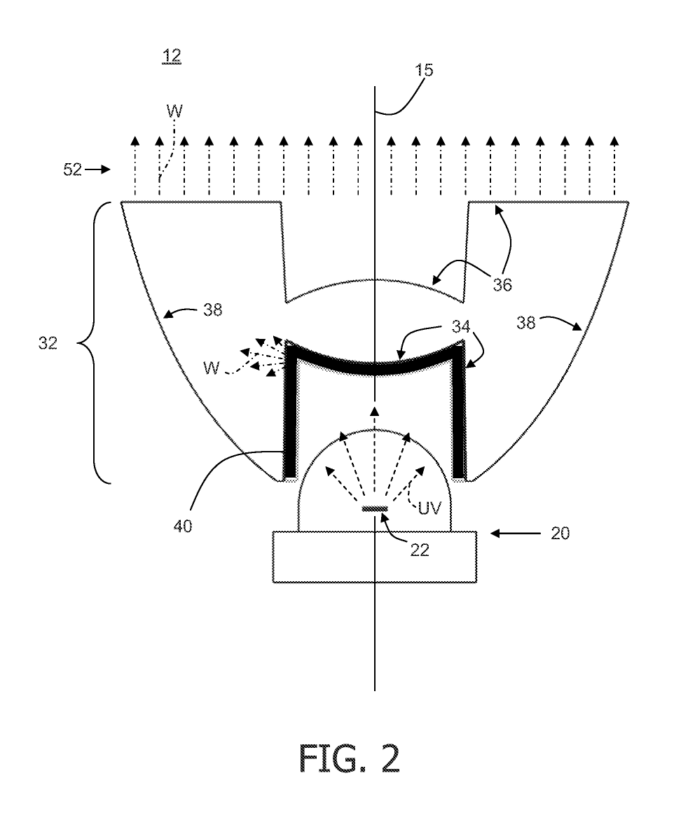

The luminescent layer 40 comprises luminescent material or a mixture of luminescent materials. The luminescent layer 40 may comprise separate layers (not shown) of luminescent material. In an embodiment of the illumination system 10 in which the separate layers comprise substantially the same luminescent material or the same mixture of luminescent materials, the color of the beam of light 50 is substantially determined by the number of separate layers applied to the light input window 34 of the collimator 30. Alternatively, the separate layers may comprise different luminescent materials or different mixtures of luminescent materials. In such an embodiment the specific combination of layers comprising different luminescent materials or comprising different mixtures of luminescent materials determines the color of the beam of light 50. Commonly used luminescent materials are, for example, Y₃Al₅O₁₂:Ce³⁺ (further called YAG:Ce) which converts light of the primary color blue B into light of the primary color yellow Y. Combining YAG:Ce with a blue light emitting diode 20 may, for example, result in substantially white light being emitted from the illumination system 10. The exact color of the light emitted by the illumination system 10 depends on, for example, the concentration of the luminescent material in the luminescent layer 40, or, for example, on the thickness of the luminescent layer 40. Other commonly used mixtures of luminescent materials, for example, include (Ba,Sr)₂Si₅N₈:Eu²⁺ (further called BSSN:Eu converting blue light into amber light) with YAG:Ce together with a blue light emitting diode 20, or Lu₃Al₅O₁₂:Ce³⁺ (further called LuAG:Ce converting blue light into green light) and CaS:Eu²⁺ (converting blue light into red light) together with a blue light emitting diode 20. Other phosphors that convert blue light into red light, such as (Ba,Sr,Ca)₂Si₅N₈:Eu²⁺, (Sr,Ca)S:Eu²⁺, and (Ca,Sr)AlSiN₃:Eu²⁺, may, for example, be used instead of CaS:Eu. Other phosphors that convert blue light into green light, such as Sr₂Si₂N₂O₂:Eu²⁺, and SrGa₂S₄:Eu²⁺, may, for example, be used instead of LuAG:Ce. Using a light emitting diode 20 emitting ultraviolet light, the luminescent layer 40 may, for example, comprise a mixture of BaMgAl₁₀O₁₇:Eu²⁺ (converting ultraviolet light into blue light), Ca₈Mg(SiO₄)₄Cl₂:Eu²⁺,Mn²⁺ (converting ultraviolet light into green light), and Y₂O₃:Eu³⁺,Bi³⁺ (converting ultraviolet light into red light). Choosing a specific ratio of the luminescent materials in the luminescent layer 40 may result in the generation of substantially white light W (see FIG. 2).

The collimator 30 may be exchangeably connected to the illumination system 10 according to the invention. When, for example, the collimator 30 having a first luminescent layer 40 is exchanged for a second collimator (not shown) having a second luminescent layer (not shown) different from the first luminescent layer 40, the color of the beam of light 50 emitted by the illumination system 10 changes. Alternatively, the collimator 30 may be exchanged for a second collimator (not shown) which generates a beam of light (not shown) having a different shape and/or dimension compared to the beam of light 50 generated by the collimator 30. The collimator 30 may be exchangeably connected, for example, via screws (not shown), or, for example, via a clamping connection (not shown), or any other releasable connection means. Such an embodiment enables a relatively easy changing of the collimator and as such a relatively easy changing of the color and/or the shape of the beam of light emitted by the illumination system.

The cross-sectional view as shown in FIG. 1 is generated by intersecting the illumination system 10 with an imaginary intersecting surface (not shown) along a longitudinal axis 15 of the collimator 30. The longitudinal axis 15 extends in a direction of the beam of light 50.

FIG. 2 shows a schematic cross-sectional view of a further embodiment of the illumination system 12 according to the invention. Again, the illumination system 12 comprises a light emitting diode 20, a collimator 32 and a luminescent layer 40 arranged on the light input window 34 of the collimator 32. A difference with the embodiment shown in FIG. 1 is that a central part arranged around the longitudinal axis 15 constitutes a lens-shape for altering the collimation of the central region of the beam of light 52 emitted by the illumination system 12. Therefore, the shape of the beam of light 52 emitted by this further embodiment of the illumination system 12 according to the invention is different from the embodiment 10 shown in FIG. 1.

Due to the application of the luminescent layer 40 on the light input window 34 which, in the embodiment shown in FIG. 2, forms part of the lens-shape, the collimating effect of the lens-shape in the collimator 32 is substantially lost for the light of the predefined color and for the light emitted by the light source 20 and scattered on the luminescent layer 40. However, due to the progression of the light substantially via total internal reflection, the light converted by the luminescent layer 40 is collimated via the collimator 32 into a beam of light 52.

In the embodiment shown in FIG. 2, the light UV emitted by the die 22 of the light emitting diode 20 is, for example, ultraviolet light UV, indicated in FIG. 2 with dashed arrows. When the ultraviolet light UV impinges on the luminescent layer 40, part of the impinging ultraviolet light may, for example, be converted into light of a predefined color W. In the current embodiment, the light of the predefined color W is light of the primary color white W, indicated in FIG. 2 with dash-dot arrows. Typically, the luminescent layer 40 will convert substantially all impinging ultraviolet light UV to prevent ultraviolet light UV from being emitted by the illumination system 12. Furthermore, the luminescent layer 40 which generates light of the primary color white W generally consists of a mixture of different luminescent materials, such as BaMgAl₁₀O₁₇:Eu²⁺, Ca₈Mg(SiO₄)₄Cl₂:Eu²,Mn²⁺, and Y₂O₃:Eu³⁺,Bi³⁺. The color of the light emitted by the illumination system 12 as shown in FIG. 2 is determined by the mixture of luminescent materials in the luminescent layer 40 applied to the light input window 34 of the collimator 32.

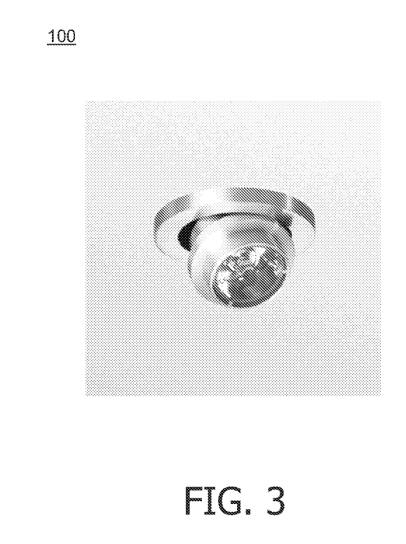

FIG. 3 shows a spotlight 100 according to the invention. The spotlight 100 comprises the illumination system 10, 12 according to the invention.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. An illumination system (10, 12) comprising a light emitting diode (20), a collimator (30, 32) and a luminescent layer (40),
the light emitting diode (20) emitting light via the luminescent layer (40) and the collimator (30, 32) in a direction away from the illumination system (10, 12),
the collimator (30, 32) being arranged for collimating the light emitted by the light emitting diode (20) to generate a beam of light (50, 52), the collimator (30, 32) having a light input window (34) for receiving light from the light emitting diode (20) and having a light output window (36) for emitting the beam of light (50, 52), the light progressing through the collimator (30, 32) substantially via total internal reflection,
the luminescent layer (40) comprising a luminescent material being arranged for converting at least part of the light emitted by the light emitting diode (20) into light of a predefined color, the luminescent layer (40) being applied to the light input window (34) of the collimator (30, 32).

2. Illumination system (10, 12) as claimed in claim 1, wherein the collimator (30, 32) is exchangeably connected to the illumination system (10, 12).

3. Illumination system (10, 12) as claimed in claim 1, wherein the collimator (30, 32) comprises an edge-wall (38) connecting the light input window (34) with the light output window (36), at least part of the edge-wall (38) having a substantially parabolic shape when viewed in a cross-sectional view being generated by intersecting the illumination system (10, 12) with an imaginary intersecting surface along a longitudinal axis (15) of the collimator (30, 32), the longitudinal axis (15) extending in a direction of the beam of light (50, 52).

4. Illumination system (10, 12) as claimed in claim 1, wherein the luminescent layer (40) comprises a mixture of luminescent materials.

5. Illumination system (10, 12) as claimed in claim 1, wherein the luminescent layer (40) comprises a plurality of layers of luminescent materials.

6. Illumination system (10, 12) as claimed in claim 5, wherein the luminescent materials in the individual layers of the plurality of layers are different.

7. Illumination system (10, 12) as claimed in claim 1, wherein a central wavelength of the light emitted by light emitting diode (20) is within a range between 400 nanometers and 490 nanometers.

8. Collimator (30, 32) for use in an illumination system (10, 12) according to claim 1, the collimator (30, 32) being arranged for collimating light emitted by a light emitting diode (20) to generate a beam of light (50, 52), the collimator (30, 32) having a light input window (34) for receiving light from the light emitting diode (20) and having a light output window (36) for emitting the beam of light (50, 52), the light progressing through the collimator (30, 32) substantially via total internal reflection,
the light input window (34) of the collimator (30, 32) comprising a luminescent layer (40) comprising a luminescent material being arranged for converting at least part of the light emitted by the light emitting diode (20) into light of a predefined color.

9. Spotlight (100) comprising the illumination system (10, 12) as claimed in claim 1.
